(19) United States
(12) Patent Application Publication
(10) Pub. No.: US 2024/0071058 A1
(43) Pub. Date: Feb. 29, 2024

(54) Microscopy System and Method for Testing a Quality of a Machine-Learned Image Processing Model

(71) Applicant: Carl Zeiss Microscopy GmbH, Jena (DE)

(72) Inventors: Manuel Amthor, Jena (DE); Daniel Haase, Zoellnitz (DE)

(21) Appl. No.: 18/235,529

(22) Filed: Aug. 18, 2023

(30) Foreign Application Priority Data
Aug. 25, 2022 (DE) 10 2022 121 543.1

(51) Int. Cl. G06V 10/776; G06T 7/00; G06V 10/70; G06V 10/774; G06V 20/69

(52) U.S. Cl. CPC G06V 10/776; G06T 7/0002; G06V 10/768; G06V 10/774; G06V 20/698; G06T 2207/10056; G06T 2207/20081; G06T 2207/30168

(57) ABSTRACT

A microscopy system comprises a microscope for image capture and a computing device. An image processing model is trained to calculate an image processing result from a microscope image. A quality testing program makes a quality statement regarding a quality of the image processing model from learned model parameter values of the image processing model.

### REFERENCE TO RELATED APPLICATIONS

The current application claims the benefit of German Patent Application No. 10 2022 121 543.1, filed on 25 Aug. 2022, which is hereby incorporated by reference.

### FIELD OF THE DISCLOSURE

The present disclosure relates to a microscopy system and a method for testing a quality of a machine-learned image processing model.

### BACKGROUND OF THE DISCLOSURE

The importance of the role of machine-learned image processing models is continuously increasing in modern microscopy systems. Machine learning models are used, for example, to automatically localize a sample or for an automated sample analysis, for example in order to measure an area covered by biological cells by segmentation or to automatically count a number of cells. Learned models are also employed to virtually stain sample structures or for image enhancement, e.g. for denoising, resolution enhancement or artefact removal.

In many cases microscope users train such models themselves with their own data. Microscopy software developed by the Applicant allows users to carry out training processes using their own data even without expertise in the area of machine learning. This is important as it helps to ensure that the model is suitable for the type of images handled by the user. Efforts are also being made to automate to the greatest possible extent training processes that incorporate new microscope data. In particular in cases where a training process was not designed by a machine-learning expert, it is imperative that the quality of the learned model be checked by means of a quality control.

A model quality is customarily captured by training or validation metrics: for a segmentation, for example, it is possible to calculate the pixel-wise accuracy of the segmentation or the ratio of a correctly segmented area to the sum of the total segmented area and the correct area (Jaccard similarity index/Intersection over Union (IoU)). Other widely used quality criteria are the overall recognition rate (ORR) or the average recognition rate (ARR).

These training and validation metrics can also suggest a high model quality in cases where the model has not actually been trained successfully. This is the case, for example, in the case of an overfitting, where the model learns the training data by rote but is unable to generalize to new data. The calculated model quality is also strongly dependent on the validation data used: if not selected carefully, validation data can lead to false suggestions of a high model quality. The detection of models that generalize poorly is difficult because any learned biases, in particular a value in a layer of the model that is independent of the input data, are not captured. The provision of sufficient and appropriate validation data can also be problematic.

To illustrate this issue, an exemplary problem that occurs when a quality of a learned model is tested based on the model outputs is explained in the following. For example, with validation and test data, the model outputs are always assessed. As validation and test data are not used in the training to adjust the model parameter values, model outputs generated for validation and test data should theoretically enable an accurate quality statement. In reality, however, this approach allows different problems to go undetected. The division of the provided image data into validation data, on the one hand, and training data (based on which the adjustment of the model parameter values is calculated), on the other, is particularly crucial for model quality. In this regard, a simple random division is generally insufficient. For instance, the image data provided from microscope systems can originate from fifty different laboratories which respectively exhibit systematic differences relative to one another. If there is a random division into training and validation data, both the training data and the validation data will contain images from microscope systems of all fifty laboratories. Following a successful training, an analysis of the model outputs generated for the validation data will suggest a high model quality. If the model is now used in the inference phase for image data from a microscope system of another laboratory that likewise exhibits a systematic difference relative to the fifty laboratories of the training, the model can end up furnishing low-quality results. In order to detect this problem, it is preferable to use images from microscope systems of a portion of the fifty laboratories solely as training data and images from microscope systems of another portion of the fifty laboratories solely as validation data. An analysis of the model outputs generated for validation data thus becomes instructive for the question of how well the model is able to process microscope images that originate from a microscope system of a laboratory not considered in the training. There can be manifold systematic differences between laboratories, e.g., relating to a provided laboratory lighting, individual artefacts of the image-capturing microscope, pixel errors of the camera used or differences in the display of captured images (e.g. text inserted above or next to the image data of the camera; image format or black bars next to the actual image data of the camera). Structural differences can also occur with one and the same microscope, e.g. as a function of the day of image capture in the event of a different ambient lighting on different days. The division of images into training and validation data thus becomes a complex task. Especially non-experts can easily make mistakes here. With conventional quality testing, there is a risk in such cases that a low model quality remains undetected.

There is thus a general need to provide more informative quality testing methods for machine-learned processing models.

A supervision of a model training and a testing of a learned model are described, for example, by the Applicant in DE 10 2020 206 088 A1 and in DE 10 2020 126 598 A1. In particular model outputs are compared with predefined validation data in these documents. A supervision of outputs of a learned model with which potential errors in the model prediction can be intercepted was also described by the Applicant in DE 10 2019 114 012 A1. An estimation of the model quality also occurs in this document based on validation data. In the German patent application DE 10 2021 100 444, a model robustness vis-à-vis input data variations is analyzed, which is likewise based on the use of validation data.

As background information, reference is further made to X. Glorot et al. (2010), “Understanding the difficulty of training deep feedforward neural networks”, Proceedings of the Thirteenth International Conference on Artificial Intelligence and Statistics, PMLR 9:249-256, 2010. This article describes typical steps in the training and validation of a neural network. It also explains how suitable values for, e.g., the learning rate as well as designs and parameters of the activation functions of a model can be determined. Learnable parameters of an activation function should assume, e.g., values that prevent a saturation (i.e. an invariably identical output of the activation function regardless of input data).

Characteristics of activation functions in learned models are described in: K. He et al. (2015), “Delving Deep into Rectifiers: Surpassing Human-Level Performance on ImageNet Classification”, arXiv:1502.01852v1 [cs.CV] 6 Feb. 2015.

Significant improvements in terms of a reduction of the number of model parameters to be learned and in terms of an independence of the model parameters from one another are described in: HAASE, Daniel; AMTHOR, Manuel, “Rethinking depthwise separable convolutions: How intra-kernel correlations lead to improved MobileNets”, arXiv:2003.13549v3 [cs.CV] 13 Jul. 2020.

### SUMMARY OF THE DISCLOSURE

It can be considered an object of the invention to provide a microscopy system and a method which enable to process a microscope image reliably with a high quality.

This object is achieved by the microscopy system and the method with the features of the independent claims.

A microscopy system according to the invention comprises a microscope for image capture and a computing device. The computing device is configured to train, using training data, an image processing model to calculate an image processing result from at least one microscope image. The computing device further includes a quality testing program for testing a quality of the image processing model. The quality testing program is configured to make a statement on a quality of the image processing model from learned model parameter values of the image processing model.

In a computer-implemented method according to the invention for testing a quality of a machine-learned image processing model designed to calculate an image processing result from at least one microscope image, learned model parameter values of the image processing model are input into a quality testing program. The quality testing program is designed to make a statement on a quality of the image processing model from input model parameter values. Based on the input learned model parameter values, the quality testing program calculates a statement regarding a quality (also referred to in the following as a quality statement) of the image processing model.

In contrast to known approaches to quality testing, the model parameter values themselves are analyzed according to the invention and not (or not exclusively) outputs of the image processing model to be evaluated. The inventors have discovered that model parameter values of successfully learned models differ appreciably from those of models that only appear to have been successfully learned. For example, an overfitting can remain undetected in an analysis of model outputs generated from validation data, in particular in cases of a non-ideal division of a dataset into training and validation data, as explained in the foregoing in relation to the background of the invention. In the event of a non-ideal training, an overfitting generally even remains undetected when an input data variation is carried out to test the robustness of the model. However, in overfitted models, certain model parameter values (the weights of the filters of convolutional layers of a CNN) appear very noisy, whereas better generalizing models exhibit more structures in these model parameter values, i.e. the weights of a filter manifest a structure that is clearly different from noise. An analysis of the model parameter values thus enables a quality statement that advantageously complements conventional quality evaluations and reveals model weaknesses that would otherwise remain undetected. With the analysis of the model parameter values, the invention differs decisively from conventional methods of quality testing.

With the invention even microscope users who are not acknowledged machine-learning experts can successfully train an image processing model using their own image data so as to subsequently be able to carry out a high-quality and reliable image processing with the learned image processing model.

### Optional Embodiments

Variants of the microscopy system according to the invention and of the method according to the invention are the object of the dependent claims and are explained in the following description.

### Quality Testing Program

The quality testing program can be or can comprise a machine-learned model and/or a non-learned testing algorithm. A quality statement pertaining to entered model parameter values is made based on predefined evaluation criteria. In particular, the quality statement can be calculated as a quality measure derived from the learned model parameter values. Optionally, a quality measure derived from the learned model parameter values can be compared with reference values in order to provide a quality statement.

The quality statement can be, e.g., a classification into one of a plurality of classes indicating a quality of the image processing model. Alternatively, the quality statement can be a value in a continuous interval and be indicative of the quality of the image processing model. Quality can be understood, e.g., in terms of a generalizability of the image processing model and/or in terms of the presence of ineffective groups of model parameters, as explained in greater detail later on.

### Evaluation Criteria for the Quality Statement

The quality testing program can make the quality statement based on evaluation criteria relating to the model parameter values. Generally speaking, any model parameters of the image processing model can be used for this purpose such as, for example, filter weights of a convolution layer. The evaluation criteria can in particular relate to one more of the following:
a randomness of the model parameter values. Randomness can be quantified, for example, via entropy (or by a measure of entropy, e.g. a data compressibility, or a similar measure such as, e.g., the variance between directly adjacent model parameter values of a filter). If the randomness or entropy lies above a reference value, this can be interpreted as a sign of an overfitting and thus as indicative of an inadequate model quality or low quality measure. The randomness or entropy is calculated for a group of model parameter values, e.g. for the filter weights of a kernel of a convolutional layer. A kernel is a matrix, e.g. a 3×3 or 5×5 matrix, with which input data are discretely convolved. The entries of the matrix are called filter weights or model parameter values. A convolutional layer can comprise many kernels, e.g., over a hundred or over a thousand. An entropy can be captured for each of the kernels and summed to give a total value for all kernels in a convolutional layer. A noise of filter weights, as commonly encountered in the event of an overfitting, corresponds to a high entropy.
a similarity of a group of model parameter values (e.g. filter values) to known or expected distributions. Distributions typical of a high or a low quality measure can be predefined. For example, different filter masks associated with a high quality measure can be predefined for a first convolutional layer. The more the model parameter values of a first convolutional layer of the image processing model resemble some of these filter masks, the higher the model quality. Typical values of model parameters of activation functions are indicated, for example, in the article by He et al. mentioned in the introduction. It is thus possible to extract model parameter values of activation functions from a correctly trained image processing model and to summarize these values as a distribution. By respectively obtaining such a distribution from a plurality of correctly trained image processing models, it is possible to obtain an average or typical distribution of the model parameter values of, e.g., activation functions. The more a distribution of model parameter values of an image processing model to be evaluated deviates from the typical distribution, the more likely it is that there is an inadequate model quality.
an energy of groups of model parameter values, in particular an energy of filter weights of a convolutional layer. The energy can be defined as proportional to the sum of the absolute values or squares of the filter weights. It is possible to calculate a total energy for all filter weights of the same filter kernel and/or a total energy for all filter weights of a convolutional layer. The energy or total energy is compared with predefined reference values. The reference values can also depend on, e.g., the model architecture, the location of the convolutional layer in the network and/or average pixel values of training images. A higher quality measure can be awarded as energy increases; conversely, a lower quality measure can be assigned if the energy falls below a predefined energy value.
a presence of inactive (“dead”) filters in the image processing model. The quality measure can indicate a poorer quality, the more dead filters are present. Dead filters or filter masks have an infinitesimal value at any point and thus no longer contribute to the output of the image processing model. A dead filter can also be defined by model parameter values that lie exclusively below a predetermined threshold. The threshold value can optionally be determined as a function of the training data, since the training data provides insight into whether the contribution of the filter to the model output is insufficiently small or whether it makes a contribution at all. In the case of a filter mask of a CNN, the threshold can also be determined as a function of a bias of a subsequent activation function, or more generally as a function of other model parameter values.
an invariability of model parameter values of activation functions over a plurality of training steps. An activation function is a non-fully linear function that receives an output x from a preceding layer, e.g. from a convolutional layer in a CNN. The ReLU function f(x)=max(0,x+b) is frequently used as an activation function, wherein the bias b is a model parameter to be learned. In variants of the ReLU (rectifying linear unit), the activation function can be defined in segments and have linear segments of different gradients. The quality measure can indicate a poorer quality, the more model parameter values of activation functions (in particular the bias values) remain unchanged over a plurality of training steps. This is the case with “dying ReLU” filters, which cease to change over a plurality of iterations because they no longer receive a gradient. Large weight updates can cause the input into an activation function to be invariably negative or smaller than the bias, so that the output of this activation function is invariably zero regardless of the input data. Such an activation function and associated preceding units in the network thus become ineffective. A lower quality measure is assigned in this case. Parts of a network that have no effect can be detected relatively easily and reliably via the model parameter analysis according to the invention, which an analysis of the model outputs (e.g. using validation data and typical validation metrics) does not allow.
a presence of structures in groups of model parameter values. The structures in question can be, e.g., structures such as edges or blobs (round or oval structures that can resemble bubbles) in a filter mask of a convolutional layer. The quality measure can be lower, the fewer structures are present. More generally, upper and lower limits for a number and/or complexity of structures can be predefined; beyond these limits, a poorer quality measure is assigned. The evaluation of existing structures can depend on the position of a convolutional layer in the network. While there should mainly be simple structures like edges or ovals in the first layer or first convolutional layers, more complex structures in subsequent layers can be associated with a high model quality.
a memorization, i.e. learning by rote, of specific or complex structures of the training images in filter masks of the image processing model. For example, it can occur that a filter mask of a first layer memorizes lines at a certain angle, as found in the training images, and learns a corresponding response. If the lines in question are irrelevant structures which do not occur or occur less frequently outside the training images, the image processing model is less likely to generalize well. If a memorization is detected, in particular in the first convolutional layer or in a predetermined number of convolutional layers at the beginning of the network, a lower model quality is inferred.
a color distribution in filter masks of the image processing model, for example in filter masks of a first convolutional layer or of certain convolutional layers located in particular at the beginning of the model. In order to process a plurality of color channels of input data, a filter mask can comprise a plurality of 2D matrices, which are respectively discretely convolved with each color channel of the input data. For example, a filter mask of a first convolution layer can comprise three 2D matrices for processing an input RGB image. These three matrices can thus be associated with red, green and blue so that their entries collectively yield RGB colors. A color distribution indicates that different colors dominate as a function of their position in the filter mask, for example that in three 3×3 matrices one color dominates in the top-left area in the 3×3 matrices and another color dominates in the bottom-right area in the 3×3 matrices. A distribution with two locally predominant colors within a filter mask is typical in particular in the first convolution layer of correctly trained image processing models, because it allows a color transition in the input image to be recognized. A higher quality measure can be awarded, e.g., when a filter mask contains two complementary colors/when a given convolutional layer contains a plurality of filter masks each with two complementary colors.
a ratio of bias values of activation functions to one another, and/or a ratio of a bias value of an activation function to an energy of input data. These ratios allow an estimation of whether a bias of an activation function has a disadvantageously high or low value as the result of which the activation function is always active (outputs a non-zero result) or always inactive, e.g. always outputs only zero, largely independently of input data.

Filter masks or other groups of model parameter values can also be analyzed to ascertain which input they respond to most. A memorization of image content of the training data, for instance, can also be established with accuracy in this manner. It is also possible to capture outputs calculated with model parameter values during or after the training. An output in this context does not refer to the final output of the image processing model, but to a variable calculated with the model parameter that is fed to a subsequent layer in the image processing model. For example, an inactive or dead filter can also be detected based on the outputs, in particular when an activation function following the filter mask always outputs the same value regardless of the data input into the image processing model.

### Quality Testing Program: Machine-Learned Model

The quality testing program can be or comprise a machine-learned model (testing model) that is in particular trained to make the quality statement based on one or more of the aforementioned evaluation criteria. Optionally, further features can be considered in addition to the model parameter values, as described in greater detail later on.

It is not necessary to enter the values of all model parameters of an image processing model into the testing model. In the case of image processing models with convolutional layers, for example, at least some or all of the filter masks of the image processing model can be input into the testing model. In particular in the case of filter masks, the model parameter values can be entered into the testing model in the form of images or image stacks. Entries of convolution matrices of the filter masks are used as a greyscale value or as a brightness value of an RGB color channel to this end. If model parameter values are entered in the form of image data, it is possible to take into account their relative position to one another (in particular their position within a filter mask).

An architecture of the testing model can take in principle any form. For instance, the testing model can be designed as an artificial neural network and can in particular comprise a convolutional neural network (CNN) or a sequential model (recurrent neural network, RNN), an LSTM or a transformer.

A training of the testing model can be implemented as a supervised learning. In this case, the training data comprises respective sets of model parameter values with an associated quality measure as an annotation. For the evaluation criterion “color distribution in filter masks”, the training data comprises, e.g., a plurality of groups/sets of model parameter values in which color distributions respectively occur and which are thus annotated with a high quality measure, as well as a plurality of sets of model parameter values without color distributions, which are annotated with a lower quality measure. The testing model can be designed to evaluate individual filters or to evaluate all filters conjointly, e.g. as a stack of images or as a sequence in the case of a sequential model architecture. The training data of the testing model can contain respective annotations for the different filters of an image processing model or a single annotation for the entire image processing model.

A training of the testing model can alternatively be implemented by means of an unsupervised learning. For example, an autoencoder can be used for the testing model. The autoencoder is trained solely with sets of model parameter values of image processing models that correspond to a model quality defined as high. After completion of the training, the more sets of model parameter values deviate from the sets of model parameter values of the training, the worse they can be reconstructed by the bottleneck of the autoencoder. It is consequently possible to detect unusual or bad filters based on the reconstruction error of the autoencoder, in which case a low model quality of the image processing model is inferred.

It is also possible to use a generative model instead of an autoencoder. Sets of model parameter values of image processing models that have been categorized (e.g. manually) as suitable are parameterized by a generative model. The generative model should thus be able to reconstruct a set of input model parameter values analogously to an autoencoder. In order to evaluate an image processing model, a reconstruction error of the generative model is considered. The greater the error, the more the model parameter values deviate from optimal model parameter values as used in the training of the testing model. Consequently, a lower model quality is inferred.

It is also possible to estimate a principal component analysis (PCA) for filters of an image processing model. It is determined how many components are required in the PCA to replicate a variance of the filters. A large number of components, for example above a threshold, indicates noisy filters, which is characteristic of a low model quality.

A reinforcement learning can also be used for the testing model. In this case, a model is learned that evaluates a plurality of image processing models based on the learned filters, wherein the reward function can be derived from the model quality.

### Quality Testing Program as a Combination of a Classical Metric and a Learned Model

The quality testing program can implement a two-step process. First, quality measures can be calculated according to the aforementioned evaluation criteria without the use of a machine-learned model. For example, it is possible to calculate for each filter matrix of an image processing model a respective quality measure and/or to calculate at least one quality measure for each of a plurality of evaluation criteria. These quality measures are subsequently entered as a feature vector into a machine-learned testing model. This has the advantage is that the dimensionality of the input data can be significantly reduced to the features that are actually relevant. The testing model in this case can be provided in the form of a neural network or also by other machine learning methods, for example by support vector machines (SVMs) or by random decision forests (RDFs).

### Input Data of the Quality Testing Program

The quality testing program can respectively evaluate groups of model parameter values together in order to calculate the quality statement. Optionally, the quality testing program can also take into account information regarding a model parameter position within the image processing model and/or contextual information in the calculation of the quality statement.

For instance, the model parameter values of a filter mask of a convolution layer can respectively be assessed together. A filter mask can be understood as a 2D matrix or a stack of 2D matrices that are discretely convolved with input data. For instance, it is possible to ascertain the evaluation criterion of an entropy for the model parameter values of such a filter mask. The model parameter position designates the location of the corresponding model parameters in the image processing model. In a correctly trained image processing model, different values are typical of, for example, filter masks of a first convolutional layer and filter masks of a later convolutional layer. Exploitable contextual information is explained in greater detail in the following.

### Contextual Information

In addition to the model parameter values, the quality testing program can also take into account contextual information to calculate the quality statement. The contextual information can, for example, relate to or be one more of the following:
initial values of model parameters of the image processing model. Initial values or initial weights are relevant in particular for an evaluation of currently learned weights during an ongoing training. The initial values can also be useful for the evaluation of ready-trained models, as there can be a correlation between initial values and a model quality of the image processing model.
an evolution of the model parameter values over a training of the image processing model. Earlier values from the training are thus also taken into account for a model parameter in addition to the final/current model parameter value. For example, it is possible to take into account all values from an initial weight, via intermediate results, up to a ready-trained weight or up to a current weight of a still ongoing training. Based on the evolution of the model parameter values, it is possible to detect, e.g., the aforementioned ineffective activation functions.
a model architecture of the image processing model. The structure of the image processing model can have an effect, for example, on how filter masks should typically look.
training data of the image processing model. Based on the training data, it can be estimated how filters (in particular in the first convolution layer) of the image processing model should look. If, for example, the learned filters are structure-based although the training data only permits shape features, it is possible to infer a low model quality. Shape features alone without structural information are contained, e.g., in microscope images in the form of segmentation masks.
information regarding an application for which microscope images were captured as training data of the image processing model. The application can relate, for example, to a tissue section analysis, a material/rock analysis or an analysis of electronic components; information regarding a microscope or microscope settings with which microscope images were captured as training data of the image processing model, for example illumination and detection settings or a contrast type (fluorescence, bright field, phase contrast, DIC, etc.); a user identification with which characteristics that occur more frequently statistically for a user can be taken into account, for example regarding microscope settings used, sample types or image characteristics of captured microscope images; or a specification of a sample type depicted in microscope images used as training data of the image processing model.

### Image Processing Model

The image processing model to be tested can be designed for, inter alia, regression, classification, segmentation, detection and/or image-to-image transformation. The image processing model can in particular be configured to calculate at least one of the following as an image processing result from at least one microscope image:
a statement regarding whether certain objects are present in the microscope image. This can include an object or instance re-identification by means of which it is in particular checked whether an object, an object type or an object instance identified in one microscope image is also depicted in other microscope images.
an inverse image transformation by means of which an inverse of a given image transformation is estimated.
geometric specifications relating to depicted objects, e.g. a position, size or orientation of an object; an identification, a number or characteristics of depicted objects. It is in particular also possible to determine a confluence, i.e. a proportion of the area of the microscope image that is covered by objects of a certain type.
a warning regarding analysis conditions, microscope settings, sample characteristics or image characteristics. Microscope settings can relate to, e.g., the illuminance or other illumination settings, detection settings or a focus.
an anomaly or novelty detection. If the entered microscope image differs significantly from the microscope images of the training, an anomaly or a novelty vis-à-vis the training data is determined. The image processing model can also function as a watchdog and issue a warning in the event of discrepancies that are not predefined.
a control command, a recommendation of a control command for controlling the microscope or a microscope component, or a command/recommendation to carry out a subsequent image evaluation. The control command can relate to, e.g., a change in illumination, detection, image capture, focus, sample stage position, filters in use or the objective in use. The control command can also relate to auxiliary components in use, such as an immersion device or an adaptive optic, in particular a spatial light modulator (SLM) by means of which a wavefront is modified. A certain image evaluation can be recommended or commanded, e.g., as a function of which objects were ascertained in the microscope image. The control command can also relate to an AutoCorr setting, so that a correction ring of the objective is adjusted in order to compensate in particular aberrations.
a determination of capture parameters with which a subsequent microscope image is to be captured.
a parameter determination for a calibration, e.g. determining a position of and/or orienting at least one camera.
a specification regarding future maintenance (predictive maintenance). This can in particular be a specification of whether a particular microscope component has been subjected to wear and/or a recalibration will be necessary.
a model test result by means of which another image processing model or its output is tested, for example a model designed by Auto-ML. This model can correspond to one of the image processing models described in the present disclosure. In cases of a testing of a model output, a correction of the model output can also be recommended.
an output image in which, e.g., depicted objects are more clearly visible or are depicted in a higher image quality, or an output image in which a depiction of certain structures is suppressed. The improved visibility or higher image quality can relate to depicted objects in general, as in the case of, e.g., a noise reduction (denoising), resolution enhancement (super-resolution), contrast enhancement (e.g. an adjustment of the gamma value or a contrast spread) or deconvolution. The improved visibility can, however, also relate alone to specific objects, as in the case of a transformation between different contrast types, whereby a virtual staining of specific structures is achieved. For example, the transformation can occur between the contrast types bright field and DIC (differential interference contrast). A suppression of structures can occur, e.g., through an artefact removal or through a detail reduction of a background. The artefact reduction does not necessarily have to relate to artefacts already present in captured raw data, but can also relate to artefacts that are created through image processing, in particular in cases of a model compression. A model compression simplifies a machine-learned model in order to reduce the memory or computational requirements of the model, wherein the model accuracy can be slightly reduced and artefacts can occur as a result of the model compression. An image-to-image transformation for calculating the output image can also relate to a filling-in of image regions (inpainting), e.g. a filling-in of flaws or gaps as a function of surrounding image content. The output image can also be a density map of depicted objects, e.g. by marking cell or object centers. A white balance, an HDR image or a de-vignetting can also be calculated. A white balance removes a distorting color or hue from the input microscope image so that objects that are actually colorless are depicted as colorless in the output image. In an HDR image, a scale of possible brightness differences per color channel is increased compared to the input microscope image. De-vignetting removes an edge shading of the input microscope image or in general other effects that increase towards the edge of the image, such as a change in color, imaging errors or a loss in image sharpness. A signal separation (“unmixing”) is also possible in which one or more signal components are extracted, e.g. in order to estimate an extraction of a spectral range from a captured image. The image processing model can also comprise a generator of a GAN, e.g. of a StyleGAN.
a classification result that specifies a categorization into at least one of a plurality of possible classes as a function of a depicted image content of the microscope image. Different classes can relate to, e.g., the sample type, the sample carrier type or characteristics of the same, e.g. a size or number of certain objects or sample components. The presence of objects in the microscope image or in certain image regions can also be checked. Objects can comprise, e.g., cells, viruses, bacteria, parts of the same or particles. It is also possible to classify an object status, e.g. a cell stage, wherein it is in particular possible to discriminate between living and dead cells. The classes can also relate to microscope characteristics, microscope components or a capture type or an aptness for subsequent measuring and/or processing steps. The classification result can also relate to an input into the model in the form of a point cloud. The point cloud represents measurement results or feature vectors of microscope images in a dimensionally reduced feature space. The classification can also be a quality assessment, e.g. regarding the image capture or an image processing step carried out beforehand. A classification can optionally take the form of an ordinal classification in which a plurality of possible classes form an order, e.g. in the case of a quality assessment of sample carriers or a size estimation of depicted objects. A one-class classification is also possible in which it is estimated whether a certain class is present without defining another class in more detail. In all examples, a probability of class membership is specified. In particular in the case of an ordinal classification, it is also possible to estimate an intermediate result between predefined classes. The classifications mentioned in the foregoing can optionally be implemented via an “open set classification” in which it is detected whether input data stems from a distribution of the training data and can thus be assigned to one of the known classes, or whether it pertains to a new class that was not taken into account in the training of the model.
a regression result, which in principle can relate to the examples mentioned with respect to a classification or to, e.g., a determination of a fill level for sample vessels, a focus determination, an image quality determination or a height determination for multi-well plates, other sample carriers or other objects.
a light field calculation by means of which a 3D image of the sample is estimated from at least one input microscope image or input image data.
a segmentation, in particular a semantic segmentation or instance segmentation, or a detection of certain structures, e.g. of: a sample area, different sample types or sample parts, one or more different sample carrier areas, a background, a microscope component (e.g. holding clips or other parts for holding a sample carrier) and/or artefacts. A segmentation can occur by means of an interactive segmentation in which a user selects, in a one-off selection or in a number of iterations, image regions in the microscope image which should or should not belong to an object to be segmented. The segmentation can also be a panoptic segmentation in which a semantics and an instance of segmented objects is indicated. A detection can be understood as a specification of whether one or more of the aforementioned structures are present in the image, or as a specification of a location of one or more of said structures, wherein a specification of location can occur by means of image coordinates or, e.g., by means of a frame around the corresponding structure, which is generally called a bounding box. Specifications of size or other geometric object characteristics can also be output by the detection in a list.
a data reduction, by means of which a compressed representation of the entered at least one microscope image is produced. The data reduction can in particular take the form of a sparse or compressed representation (compressed sensing).
a model compression of a machine-learned model by means of which the model is simplified. It is possible to attain, for example, a runtime improvement by means of a parameter reduction. The model to be compressed can in particular correspond to one of the image processing models described in the present disclosure.
a model selection: It is ascertained which of a plurality of machine-learned models is to be used for a subsequent analysis or image processing.
an evaluation of a machine-learned model or of a model architecture of a machine-learned model, after completion of a model training or during a still ongoing model training (training observer).
an evaluation of a model output of an image processing model in order to calculate a refinement of model parameters of the image processing model by means of continuous active learning.
training data for a further machine-learned model. The training data in question can be constituted by any of the outputs mentioned here.
a supervision result of a workflow of a microscope. Image data can be assessed to check whether certain events have occurred, e.g. whether a general or specific sample carrier or a calibration object has been placed on a microscope stage. Spectrogram data of captured audio data or other representations of audio data can also be evaluated for the supervision of a workflow.
a confidence estimate of an image processing result of another image processing model, which can correspond, e.g., to one of the image processing models described in the present disclosure.
a selection of images from an image dataset, wherein selected images resemble the entered microscope image (image retrieval).

Training data of the image processing model can be chosen according to the aforementioned functions. The training data can contain microscope images or images derived from the same, which act as input data for the image processing model. In a supervised learning process, the training data also comprises predefined target data (ground truth data) with which the calculated image processing result should ideally be identical. For a segmentation, the target data takes the form of, for example, segmentation masks. In the case of a virtual staining, the target data takes the form of, e.g., microscope images with chemical staining, fluorescence images or generally microscope images captured with a different contrast type than the microscope images to be entered.

### Architecture of the Image Processing Model to be Analyzed

An architecture of the image processing model to be analyzed can in principle take any form as long as it comprises model parameter values to be learned. It can comprise a neural network, in particular a parameterized model or a deep neural network containing in particular convolutional layers. The image processing model can comprise, e.g., one or more of the following:
encoder networks for classification or regression, e.g. ResNet or DenseNet;
an autoencoder trained to generate an output that is ideally identical to the input;
generative adversarial networks (GANs).
encoder-decoder networks, e.g. U-Net;
feature pyramid networks;
fully convolutional networks (FCNs), e.g. DeepLab;
sequential models, e.g. recurrent neural networks (RNNs), long short-term memory (LSTM) or transformers;
fully connected models, e.g. multi-layer perceptron networks (MLPs).

A training of the image processing model starts with initial values of model parameters, which are iteratively adjusted in the course of the training. These values of the model parameters are evaluated (during or following the training) by the quality testing program. The expressions “weights” or “model weights” can be understood as synonymous with “model parameters” or “model parameter values”. The number of model parameters of the model can be fixed or varied. For example, a size or number of filters of a CNN can be varied and a respective training can be carried out for each variation. The number of model parameter values can be determined by hyperparameters, wherein the hyperparameters are optionally also entered into the quality testing program.

### Model Parameters of the Image Processing Model to be Analyzed

The model parameters of the image processing model to be tested can comprise, for example:
filter weights (filter masks) of the convolutional layers of a CNN;
weight matrices of fully connected layers or transformer layers; and/or
centring and scaling weights in normalization layers (e.g. BatchNorm).

Depending on the architecture of the image processing model, it is also possible to assess the values of other model parameters.

Model Testing During or after a Training

The model parameter values can be entered into the quality testing program upon completion of a training of the image processing model. It is alternatively or additionally possible for the quality testing based on the model parameter values to occur during an ongoing training of the image processing model. For example, a testing can be carried out after a predefined number of training steps. Depending on the quality statement calculated based on the model parameter values, the training is continued or aborted or optionally reinitiated with changes. A warning can also be output to a user, e.g. when a reinitiation of the training does not appear very promising even with changes. The changes for a reinitiation can relate to, e.g., hyperparameter settings and/or a data selection, as described in greater detail later on.

A stop criterion for the training can also be predefined with respect to changes in the model parameter values. It can be provided that, if the changes in the model parameter values lie below predefined limits over a plurality of training steps, the training is terminated.

### Resulting Actions in Cases of a High Quality of the Image Processing Model

If the quality statement is calculated during an ongoing training and indicates a high model quality, the training can be continued as a resulting action.

If the quality statement confirms a usability of the image processing model after completion of the training, it can be provided that the image processing model is used to calculate image processing results from microscope images to be analyzed. Alternatively, there can occur a supplemental verification of a model quality of the image processing model before the image processing model is used to calculate image processing results from microscope images.

In addition to classical metrics, supplemental verification methods can relate to, e.g., a sensitivity analysis of the model parameters, in which it is analyzed whether learned model parameters are sensitive to relevant image structures or to e.g. irrelevant artefacts. As a further verification method, it is also possible to ascertain a robustness vis-à-vis input data variations, for example by inputting two microscope images that are identical except for random or irrelevant differences into the image processing model: if the results calculated by the image processing model in these cases deviate significantly from each other, an insufficient model quality can be inferred. A supplemental verification can also take the form of a structure-based evaluation of model outputs, as described in DE 10 2020 126 598 A1. The different testing measures can be combined in a holistic model.

If the calculation of the quality statement is carried out at a microscope manufacturer, the model can be released for use at the microscope user in cases of a positive quality statement. In this example, the calculation of the quality statement and the analysis of further microscope images occur separately from each other temporally and spatially. If, on the other hand, the calculation of the quality statement is carried out at the microscopy system of a microscope user, the image processing model can be used immediately afterwards in the inference phase with data to be analyzed. In cases of a negative quality statement, on the other hand, the image processing model is not used in the inference phase.

### Resulting Actions in Cases of an Inadequate Quality of the Image Processing Model

If the quality statement categorizes the image processing model as unsuitable or deficient, it is possible to initiate a new training of the image processing model with a change as a resulting action, wherein the change relates to at least one of the following:
hyperparameters of the image processing model. For example, a learning rate (i.e. a degree to which model parameters are changed in each training step) or a learning rate schedule variation can be changed for the new training. In cases of a dead activation function or a dead filter mask, e.g., the learning rate can be reduced in order to avoid that an activation result of zero is invariably output due to an excessive adjustment of a model parameter, whereby it would no longer be possible to determine a gradient in subsequent training steps. The change for the new training can also relate to an optimizer used. An optimizer determines how model weights are changed based on determined gradients. The change can be, e.g., a switch between the Adam optimizer and a conventional stochastic gradient descent method (SGD). The change can also relate to a regularization of the image processing model, for example as described in the article cited in the introduction: HAASE, Daniel; AMTHOR, Manuel; “Rethinking depthwise separable convolutions: How intra-kernel correlations lead to improved MobileNets”, arXiv:2003.13549v3 [cs.CV] 13 Jul. 2020, cf. in particular section 3.3.2, which explains a regularization loss that reduces a redundancy of model parameters to be learned for convolutional layers.
a removal (pruning) of model parameters from the image processing model or an addition of model parameters to the image processing model. The change can also indicate whether and to what extent a neural network should be expanded or whether the architecture of the network should be changed. It is possible, for example, to add or remove filters of a CNN, to add or remove entire convolutional layers of a CNN, or to change the size of filter matrices or of a stride (the increment with which a filter mask of a CNN is moved over input data).
a division into training and validation data or a selection of training and validation data. For instance, it can occur that a filter learns a structure from images of the training data although this structure should not be relevant for the task of the image processing model (e.g. a classification). In this case, microscope images of the training data that show this structure can be removed from the training data. This modification of the training data can be carried out in an automated manner using contextual information. A division of the available microscope images into training or validation data (as which test data can optionally also be counted) can be changed, e.g., in order to increase the amount of training data, whereby a higher model quality can potentially be attained.

The new training with the change does not have to be implemented immediately and fully automatically. Instead, the change can also be recommended to a user, who can then initiate the implementation of the training with the change or carry out further modifications.

The quality testing program can determine the change based on at least the model parameter values and optionally based on the aforementioned contextual information. Contextual information regarding the image processing model can also be taken into account. For instance, contextual information indicating the initial values of model parameters can be taken into account in order to determine other initial values for a new training as a resulting action. For example, initial values of filter matrices that exhibit an excessively high entropy in the course of training can be changed. In cases where an activation function consistently only outputs zero from the start of the training, an initial bias can be changed for the new training so as to make a non-zero output more likely.

If the image processing model is categorized as poor, it is alternatively or additionally possible for a warning to be issued, e.g. that more training data is needed.

The quality testing program can be designed to estimate whether one of the cited changes is promising. If none of the available changes is promising, a warning can be output, in particular an appeal to expand or change the training data.

### General Features

Machine-learned models (=machine learning models) generally designate models that have been learned by a learning algorithm using training data. The models can comprise, for example, one or more convolutional neural networks (CNNs), wherein other deep neural network model architectures are also possible. By means of a learning algorithm, values of model parameters of the model are defined using the training data. A predetermined objective function can be optimized to this end, e.g. a loss function can be minimized. The model parameter values are modified to minimize the loss function, which can be calculated, e.g., by gradient descent and backpropagation.

The microscope can be a light microscope that includes a system camera and optionally an overview camera. Other types of microscopes are also possible, for example electron microscopes, X-ray microscopes or atomic force microscopes. A microscopy system denotes an apparatus that comprises at least one computing device and a microscope.

The computing device can be designed in a decentralized manner, be physically part of the microscope or be arranged separately in the vicinity of the microscope or at a location at any distance from the microscope. It can generally be formed by any combination of electronics and software and can comprise in particular a computer, a server, a cloud-based computing system or one or more microprocessors or graphics processors. The computing device can also be configured to control microscope components. A decentralized design of the computing device can be employed in particular when a model is learned by federated learning using a plurality of separate devices.

Descriptions in the singular are intended to cover the variants “exactly 1” as well as “at least one”. The image processing result calculated by the image processing model is thus to be understood as at least one image processing result. For example, an image processing model for virtual staining can be designed to calculate a plurality of differently stained output images from one input microscope image. A segmentation model can also be designed to calculate a plurality of different segmentation masks from one input microscope image.

A microscope image can be formed by raw image data captured by a microscope or be produced through further processing of the raw image data. Further processing can comprise, e.g., changes in brightness and contrast, an image stitching to join together single images, an artefact removal to remove faults from the image data, or a segmentation to produce a segmentation mask.

The characteristics of the invention that have been described as additional apparatus features also yield, when implemented as intended, variants of the method according to the invention. Conversely, a microscopy system or in particular the computing device can also be configured to carry out the described method variants.

### BRIEF DESCRIPTION OF THE DRAWINGS

A better understanding of the invention and various other features and advantages of the present invention will become readily apparent by the following description in connection with the schematic drawings, which are shown by way of example only, and not limitation, wherein like reference numerals may refer to alike or substantially alike components:

FIG. 1 is a schematic illustration of an example embodiment of a microscopy system according to the invention.

FIG. 2 illustrates processes of an example embodiment of a method according to the invention;

FIG. 3 illustrates examples of filter masks as used in example embodiments of a method according to the invention;

FIG. 4 illustrates processes of an example embodiment of a method according to the invention;

FIG. 5 illustrates processes of an example embodiment of a method according to the invention;

FIG. 6 illustrates processes of an example embodiment of a method according to the invention; and

FIG. 7 illustrates processes of an example embodiment of a method according to the invention.

### DETAILED DESCRIPTION OF EMBODIMENTS

Different example embodiments are described in the following with reference to the figures.

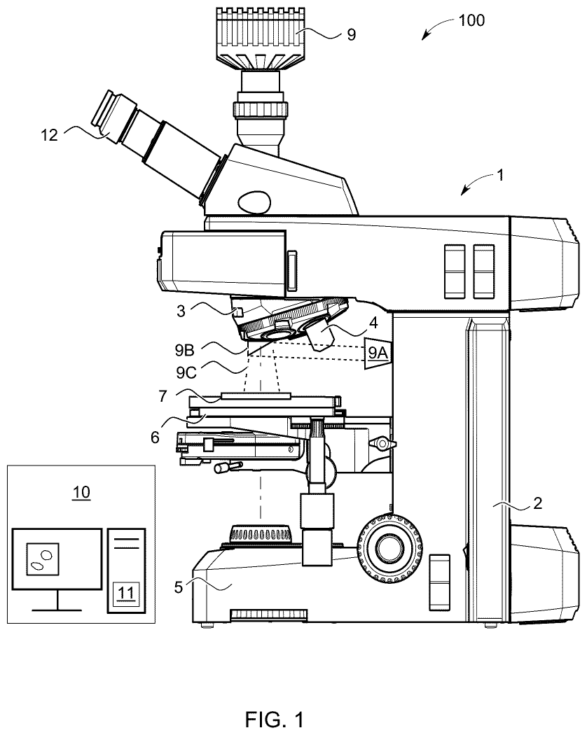

### FIG. 1

FIG. 1 shows an example embodiment of a microscopy system 100 according to the invention. The microscopy system 100 comprises a computing device 10 and a microscope 1, which is a light microscope in the illustrated example, but which in principle can be any type of microscope. The microscope 1 comprises a stand 2 via which further microscope components are supported. The latter can in particular include: an illumination device 5; an objective changer/revolver 3, on which an objective 4 is mounted in the illustrated example; a sample stage 6 with a holding frame for holding a sample carrier 7; and a microscope camera 9. When the objective 4 is pivoted into the light path of the microscope, the microscope camera 9 receives detection light from an area in which a sample can be located in order to capture a sample image. A sample can be to be any object, fluid or structure. In addition to or instead of the microscope camera 9, it is also possible to use an eyepiece 12. The microscope 1 optionally comprises an additional overview camera 9A for capturing an overview image of a sample carrier 7. A field of view 9C of the overview camera 9A is larger than a field of view of the microscope camera 9. In the illustrated example, the overview camera 9A views the sample carrier 7 via a mirror 9B. The mirror 9B is arranged on the objective revolver 3 and can be selected instead of the objective 4. The mirror is omitted or a different arrangement of the mirror or some other deflecting element is provided in variants of this embodiment. In the illustrated example, the overview camera 9A views the sample stage 6 from above. Alternatively, the overview camera 9A can also be arranged so as to view the sample stage 6 from below.

In the present disclosure, a microscope image denotes an overview image of the overview camera 9A or a sample image of the sample camera/system camera 9. The microscope image is intended to be processed by a machine-learned image processing model. This model can be executed by a computer program 11, which forms part of a computing device 10. The image processing model and a quality testing of the model are described in the following with reference to the further figures.

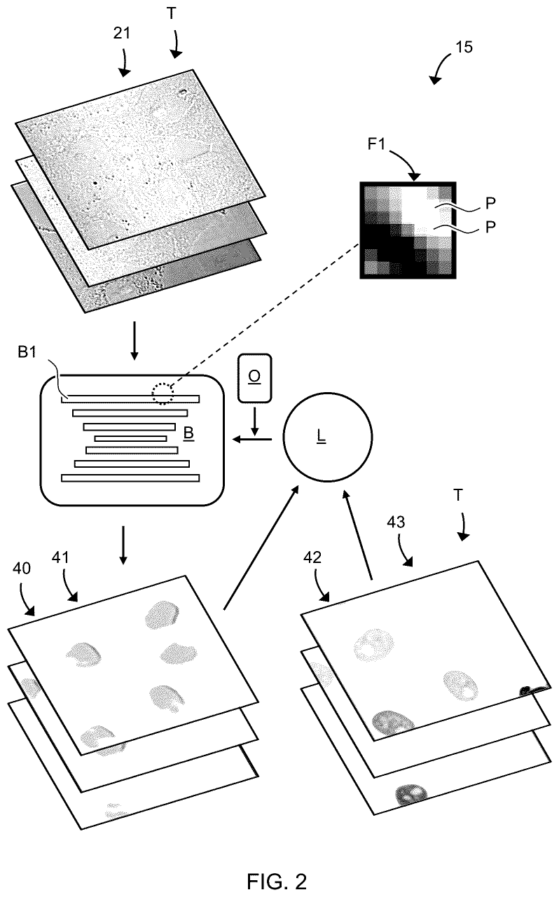

### FIG. 2

FIG. 2 schematically illustrates processes of an example embodiment of a computer-implemented method according to the invention. By means of the illustrated processes, an image processing model B is trained with training data T. The computing device 10 or the computer program 11 mentioned with reference to FIG. 1 is designed to carry out this method.

The method comprises a training 15 in which the image processing model B is learned by machine learning using training data T, i.e. model parameter values P of the model are iteratively adjusted based on the training data T. The training data T comprises microscope images 21 and associated annotations 42 as target data, in this example chemically stained images 43 registered spatially in relation to the microscope images 21.

The microscope images 21 are input into the image processing model B, optionally in groups (batches). Based on current model parameter values, the image processing model B calculates an image processing result 40—which in this example should be a virtually stained image 41—from each of the input microscope images 21. The virtually stained images 41 are entered together with the associated chemically stained images 43 into an objective function L. The objective function L here is a loss function that captures pixel-wise differences between respective pairs consisting of a virtually stained image 41 and a corresponding chemically stained image 43. A learning algorithm iteratively minimizes the loss function, to which end an optimizer O determines a change in the model parameter values of the image processing model B, e.g., by gradient descent.

The next training step begins with the changed model parameter values, wherein a further adjustment of the model parameter values occurs using others of the microscope images 21.

In the illustrated example, the image processing model B comprises a CNN (convolutional neural network) with convolutional layers which respectively comprise a plurality of filter masks. An enlargement of a filter mask F1 of a convolutional layer B1 is illustrated. The filter mask F1 comprises a matrix of numbers, which are discretely convolved with input data. The entries of the matrix are model parameters whose model parameter values P are learned through the training 15. The model parameter values P are illustrated by shades of grey in the example shown. In the illustrated case, the filter mask F1 comprises purely by way of example a 7×7 matrix and thus 49 model parameter values P to be learned. For a convolution calculation, the 7×7 entries of the filter mask F1 are multiplied by the values of 7×7 pixels of the input data and the resulting 49 products are subsequently summed so as to form an output value. The filter mask F1 is slid over the input data, whereby multiple output values are calculated. In the case of the first convolution layer, the input data can especially be the microscope image 21. Otherwise, the input data is the data output by a previous layer of the image processing model B.

Upon completion of the training 15, all model parameter values P of the image processing model B are defined. A quality of the image processing model B is typically estimated using validation data that was not used in the training 15 to adjust the model parameter values P. However, as explained in the introduction of the present description, it is not always possible to reliably detect based on the image processing results 40 (calculated in particular from validation data) whether an image processing model B actually provides an adequate quality. In particular, an overfitting can result in a false suggestion of a high model quality while, in cases of a non-ideal division of microscope images into training data and validation data, the falsity of this suggestion is not detectable or difficult to detect based on the image processing results 40.

Thus, according to the invention, other model characteristics are analyzed for the quality evaluation of the image processing model B, as described in greater detail with reference to the following figure.

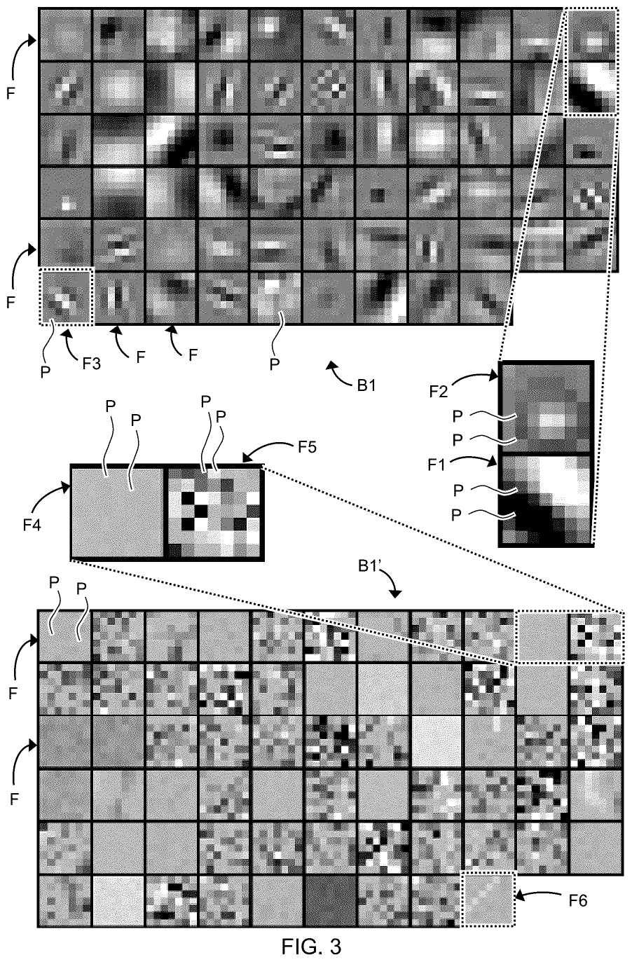

### FIG. 3

FIG. 3 illustrates model parameter values of image processing models.

Filter masks F of a convolution layer B1 are illustrated in the top part of FIG. 3. In this example, the convolutional layer B1 comprises a total of 64 filter masks F, wherein their arrangement in 11 columns and 6 rows here merely serves the purpose of a tidy illustration. Each filter mask F is slid over the input data in order to calculate a plurality of output values. The filter masks F comprise a plurality of model parameters whose values (model parameter values P) are represented as shades of grey. In this example, the convolutional layer B1 is the first convolutional layer of the image processing model B. The input data is thus a microscope image comprising three color channels, e.g. RGB channels. In order to process these three color channels, each filter mask F comprises three 2D matrices, 7×7 matrices in this example, i.e. a respective 2D matrix is used to convolve each color channel of the input image. In a typical color representation, a filter mask F is shown in color by means of a single 2D matrix, so that each of the matrix entries has a red value, a green value and a blue value; the red values are used for the convolution calculation of the red channel of the microscope image, while the green values and the blue values are used analogously for the convolution of the green and blue channels. In the black-and-white illustration in FIG. 3, the color information is not shown but only suggested by different shades of grey.

The convolutional layer B1 is part of an image processing model which is known to process input microscope images with a high quality.

The illustrated convolutional layer on the other hand, is part of an image processing model for which it is known that there is an overfitting and the image processing model processes input microscope images with an inadequate quality.

As can be seen from FIG. 3, a difference between a correctly trained image processing model and an inferior image processing model can be established based on the filter masks F or model parameter values P of the corresponding convolutional layers B1, B1′.

A filter mask F5 of the convolutional layer B1′ is representative of an overfitting: the entries of the filter mask F5 appear noisy and do not exhibit a recognizable structure. Mathematically, this can be identified by an entropy above a predefined threshold. A filter mask F4 of the convolutional layer B1′ is representative of an ineffective filter: all entries have similar values, whereby it is impossible for the convolution calculation to yield outputs that are rich in content. It is precisely when a filter mask only has small values for all three colors (symbolized by grey values in FIG. 3) and these small values occur over the entire filter mask that the filter can also be called a dead filter, which makes no or hardly any contribution to the result of the image processing model. The convolutional layer B1′ comprises many such dead filters. The filter mask F6 of the convolutional layer B1′ is an example of a structure memorized from training data, i.e. a relatively detailed replication of specific image content. By means of such memorized structures in at least the first convolutional layer, the model can process the microscope images of the training images as desired, but is likely to generalize poorly when microscope images without the memorized structure are to be processed. Memorized structures occur more frequently in overfitted models than in correctly trained image processing models.

The example filter masks F1 and F2 of the convolutional layer B1 of the correctly trained image processing model are different. The filter mask F1 is representative of a color distribution within the filter mask, wherein in the greyscale representation of FIG. 3 an increasing red value corresponds to a darker pixel and an increasing blue value corresponds to a lighter pixel. In a color distribution, different colors are predominant in different areas of the filter mask. In the filter mask F1, red predominates in the bottom-left half, while blue predominates in the top-right half; a relatively sharp edge-like transition separates the two halves. The filter mask thus responds to a certain color change in the microscope image in a certain direction. The filter mask F2 is representative of a monochrome “blob”, i.e. a roundish or oval shape, wherein numerical values decrease away from the center of the blob. Such structures are typically found in larger numbers in high-quality trained image processing models. A filter mask F3 shows a wavelet-like structure, i.e. elongated areas with alternating between light and dark sections. The three RGB values occur here at similar levels, so that this filter mask responds largely independently of color to sharp image changes in a certain direction. As can be seen in the convolutional layer B1, wavelet-like filter structures occur frequently in correctly trained models.

The filter masks F1-F6 have been explained by way of example to demonstrate that filter masks can be used to discriminate between high-quality image processing models and image processing models of an inadequate quality. Filter masks that correspond in terms of their type to the filter masks F4, F5 or F6 occur in large numbers in deficient models, but not at all or seldom in high-quality models. Filter masks that correspond in terms of their type to the filter masks F1-F3, on the other hand, are an indication of a correctly trained model.

It is thus possible based on the filter masks, or more generally based on groups of model parameter values, to make a quality statement regarding a trained image processing model. This is described in greater detail with reference to the following figure.

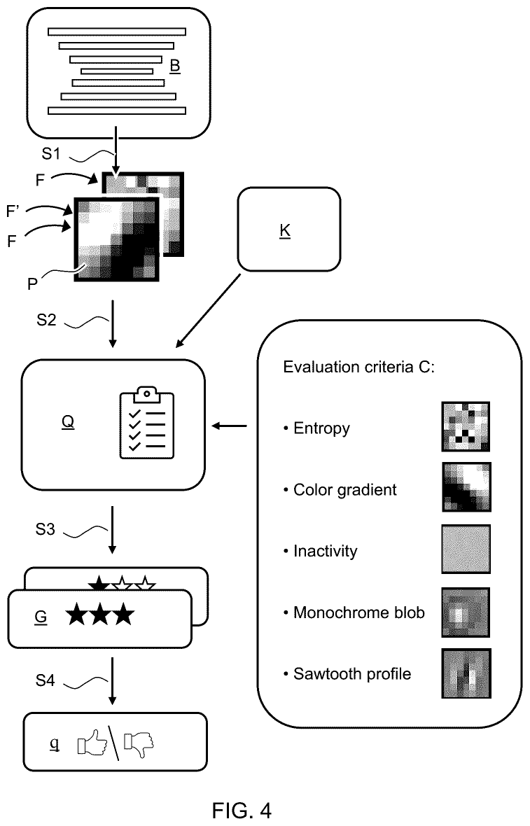

### FIG. 4

FIG. 4 illustrates processes of an example embodiment of a method according to the invention for testing a quality of an image processing model B.

In a step S1, a plurality of groups F′ of model parameter values P are extracted from the image processing model B. In this example, the groups F′ in question are filter masks F. Optionally, it is also possible for other groups of model parameter values to be extracted.

The filter masks F are entered into a quality testing program Q in a step S2. The quality testing program Q is designed to calculate an evaluation or quality measure G for the filter masks F based on evaluation criteria C. In a step S3, the quality testing program Q calculates a respective quality measure G for each input filter mask F. Next, in a step S4, a quality statement q is calculated from all quality measures G. Alternatively, the quality testing program Q can be designed to analyze a plurality of filter masks F conjointly and to calculate the quality statement q directly therefrom.

The evaluation criteria C can comprise, e.g.:

An entropy: If the entropy or noise in a filter mask exceeds a predefined limit, a poorer quality is inferred.

Color gradient: If there is a color gradient across a filter mask, a better quality is inferred.

Inactivity: In cases of dead or inactive filter masks, a poorer quality is inferred. An inactive filter mask can be detected, e.g., when all model parameter values lie below a predefined threshold. It is also possible to infer a poorer quality when a variance of the model parameter values lies below a predefined threshold. An inactivity can also be detected by an entropy that lies below a predefined minimum value.

Monochrome blob: A blob is a round structure with maximum model parameter values in the center which decrease towards the edge. With a monochrome blob, this round structure only occurs in one of a plurality of color channels. If a monochrome blob is detected, a better quality is inferred.

Similarity to predefined distributions: It is possible to ascertain a similarity of a filter mask to predefined filter masks associated with a better or worse quality. Predefined distributions can describe, e.g., wavelet-like or sawtooth structures comprising line-shaped or elongated areas with alternating light and dark sections. Light/dark can correspond to large/small values of all color channels or of only a single color channel.

Energy of the filter weights of a filter mask: The energy can be defined, e.g., as the sum of all model parameter values or as the sum of the squared model parameter values of a filter mask. If the energy lies outside predefined limits, it is possible to infer a poorer quality.

The quality testing program Q can also take into account further information (contextual information K). The contextual information K can specify, e.g., a position of the extracted model parameter values within the image processing model, for instance the convolutional layer from which the filter masks F originate. In principle, the contextual information K can relate to any characteristic of the model architecture of the image processing model B, to characteristics of the training data of the image processing model B or to characteristics of the training of the image processing model B such as hyperparameters.

The illustrated example only shows two filter masks F to be evaluated for the sake of clarity. In practical cases, however, more filter masks, for example all filter masks or at least 10% of the filter masks of the image processing model B are entered into the quality testing program Q.

The quality testing program Q can make a quality statement q using the evaluation criteria C without being constituted by a machine-learned model. It is alternatively also possible, however, for the quality testing program Q to be or to comprise a machine-learned model, as discussed with reference to the next figure.

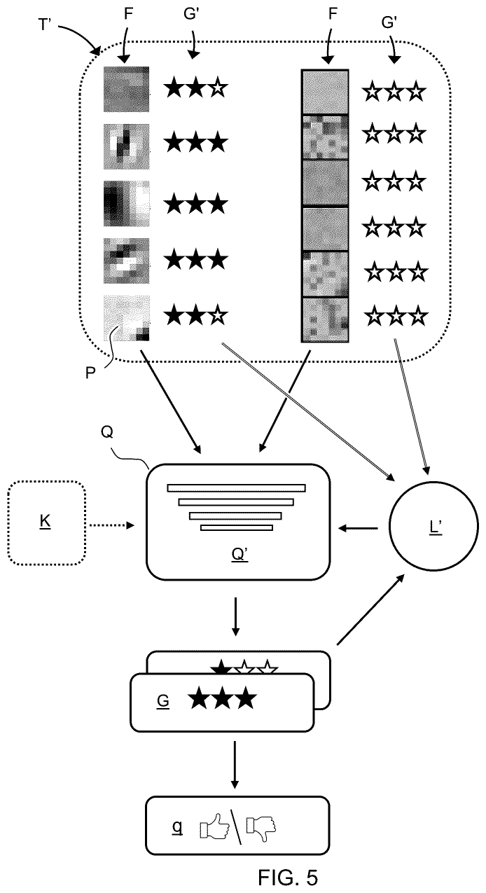

### FIG. 5

FIG. 5 illustrates a training for a quality testing program Q that is designed at least partly as a machine-learned model (testing model) Q′.

A supervised learning process is implemented in the illustrated example. Provided training data T′ for the testing model Q′ comprises filter masks F and annotations in the form of quality measures G′ pertaining to the respective filter masks F. A quality measure G′ can be a classification, for example a categorization into one of two classes (good/bad), although it is also possible for any number of further classes to be provided for intermediate gradations. Instead of classes, it is also possible to employ numbers in a continuous range of values as a quality measure. A predefined quality measure G′ can be manually annotated by a user or can in principle be generated in some other manner. For example, a user can evaluate a ready-trained image processing model and this evaluation is adopted for all filter masks.

The testing model Q′ calculates from each input filter mask F an output intended to represent a quality measure G. The calculated quality measure G is entered into a loss function L′ together with the predefined quality measure G′. The model parameter values of the testing model Q′ are thereby adjusted iteratively in an essentially known manner.

Upon completion of the training, the testing model Q′ is able to calculate a quality measure G from respective entered filter masks F. The respective calculated quality measures G are then combined in a new calculation to form a quality statement q.

In order to allow the testing model Q′ to also exploit contextual information, contextual information K pertaining to the entered filter masks F can optionally be entered in the training.

An input from which the testing model Q′ calculates a quality measure G does not necessarily have to be a filter mask F. Generally speaking, the input can be a group of model parameter values. A group can also comprise two or more filter masks, in particular a plurality of or all filter masks of a convolutional layer. Besides the learned weights of the filter masks F, it is also possible for other model parameter values to be taken into account. For instance, a group of model parameter values can comprise one or more filter masks as well as model parameter values of a subsequent activation function (e.g. a bias value). Groups of model parameter values that do not pertain to any filter masks of a convolutional layer can also be processed in the described manner.

The calculation of the quality statement q from the quality measures G can be carried out by means of a classical algorithm, without the use of a learned model, or alternatively by a part of the machine-learned testing model.

In a variant of the embodiment shown in FIG. 5, the testing model Q′ outputs the quality statement q directly without explicitly outputting a quality measure G. In this case, a single annotation can be provided for a plurality of groups of model parameter values/for a plurality of filter masks F in the training data, wherein the annotation indicates the quality of the associated image processing model. The plurality of filter masks F are entered together, e.g. as an image stack, into the testing model in this case.

While FIG. 5 shows a supervised learning by way of example, an unsupervised learning or a reinforcement learning is also possible. For instance, in an unsupervised learning, the training data can comprise exclusively groups of model parameter values from high-quality image processing models. The testing model is trained as an autoencoder and can thus reproduce input groups of model parameter values with low reconstruction error if these groups resemble the groups of model parameter values of high-quality image processing models used in the training. If the entered groups of model parameter values deviate to a greater extent from the groups used in the training, the reconstruction error is higher and it can be inferred that the input groups of model parameter values do not belong to a high-quality image processing model. Conversely, the testing model can also be trained solely with groups of model parameter values that belong to qualitatively inadequate image processing models.

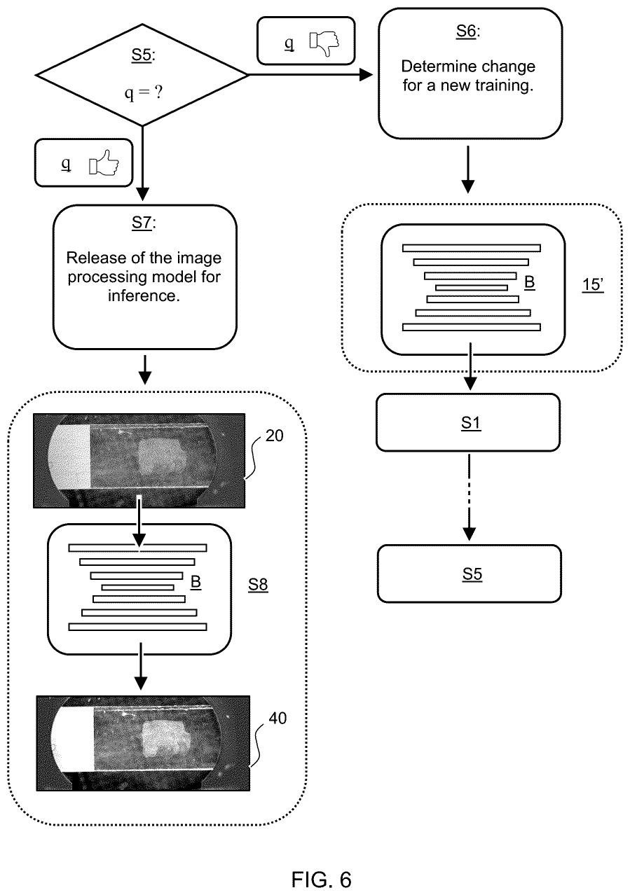

### FIG. 6

FIG. 6 illustrates actions resulting from a quality statement q regarding an image processing model B.

It is queried in a step S5 whether the quality statement q indicates a sufficient quality of the image processing model, e.g. based on a comparison of the quality statement q with a threshold value. In particular, the quality statement q can specify whether or not an overfitting of the model parameter values has occurred.

If the quality is inadequate, a change is made for a new training of the image processing model in a step S6. The change can relate to, e.g., initial values of model parameters, hyperparameters, the model architecture and/or a division into training and validation data. The change can optionally be determined by the quality testing program based on the model parameter values and optional contextual information. It is thus also possible in a variant embodiment for the change to be output by the quality testing program together with the quality statement q. There then follows a new training 15′ of the image processing model B with the change. This training can be implemented as described with reference to FIG. 2. This is followed by step S1 and the other measures described with reference to FIG. 4 in order to calculate a quality statement for the newly trained image processing model B. This, in turn, is again followed by step S5.

If it is established in step S5 that the quality statement q indicates a sufficient quality of the image processing model, in particular if an overfitting is excluded, there then follows a step S7. In S7, the image processing model B is released for the inference phase, i.e. for processing microscope images 20 to be analyzed.

In a following step S8, the image processing model B is used to process a microscope image 20 to be analyzed. The image processing model B calculates an image processing result 40, which is, for example, a quality-enhanced version of the input microscope image 20. The quality enhancement can relate to, e.g., a contrast enhancement, a white balance, a resolution enhancement, a noise suppression or a deconvolution. Other types of image processing results are also possible, as outlined in the foregoing general description.

A microscope image 20 to be analyzed and microscope images of the training data of the image processing model B can originate from the same microscope or from different microscopes. At least a portion of the microscope images of the training data can also be simulated and does not have to be captured by a microscope.

While with reference to FIG. 6 a quality statement for an image processing model was determined and used after completion of the training, it is additionally or alternatively possible for a quality statement to be determined and utilized during an ongoing training. This is described in greater detail with reference to the following figure.

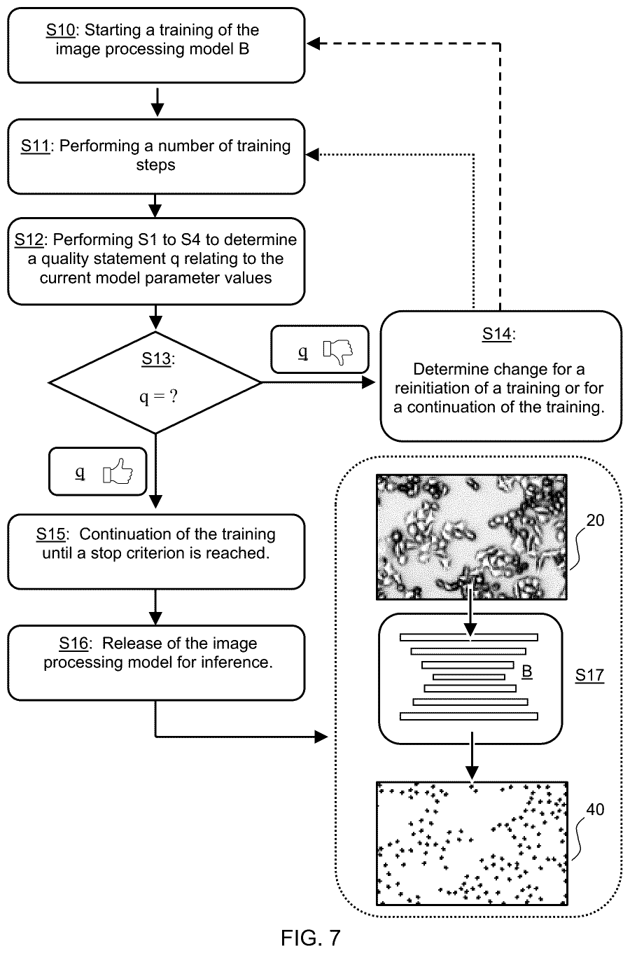

### FIG. 7

FIG. 7 illustrates processes of a method variant according to the invention in which a quality statement q is based on current model parameter values during a still ongoing training of an image processing model B.

In a step S10, a training of the image processing model B is started with initial values of the model parameters. The training is implemented for a given number of training steps. The number of steps can be predefined or can depend on a training progress. Next, as step S12, the steps S1 to S4 described with reference to FIG. 4 are carried out. In the process, the current model parameter values of the ongoing training are extracted and assessed in order to calculate a quality statement q.

Next, in a step S13, a query is issued regarding whether the quality statement q indicates a sufficient quality. If this is not the case, a change is made in a step S14. As described in relation to the preceding figure with reference to step S6, the change can relate to, e.g., initial values of model parameters, hyperparameters, the model architecture and/or a division into training and validation data. The training is either reinitiated with this change, so that the sequence reverts to S10, or the training is continued with this change, in which case the sequence reverts to S11.

If a sufficient quality is established in step S13, the training is continued without any changes (step S15) until a stop criterion is reached. During the continued training, a quality statement q can optionally be calculated any number of times for the respective current model parameter values according to steps S12-S13.

Upon reaching the stop criterion, e.g. a predefined number of training steps or epochs, the training is stopped. There then follows the release of the image processing model for the inference phase in a step 16. Optionally, additional validation checks can be carried out before S16 in order to further increase the certainty that the image processing model B is of a high quality.

After the release in step S16, there follows, in a step S17, the use of the image processing model to calculate an image processing result 40 from a microscope image 20 to be analyzed. In the illustrated example, cell centers of biological cells depicted in the microscope image 20 are localized as the image processing result 40. Other types of image processing are also possible, as explained in the foregoing general description.

The variants described for the different figures can be combined with one another. The described example embodiments are purely illustrative and variants of the same are possible within the scope of the attached claims.

### LIST OF REFERENCE SIGNS

1 Microscope
2 Stand
3 Objective revolver
4 (Microscope) objective
5 Illumination device
6 Sample stage/microscope stage
7 Sample carrier
9 Microscope camera
9A Overview camera
9B Mirror
9C Field of view of the overview camera
10 Computing device
11 Computer program
12 Eyepiece
15 Training of the image processing model
15′ New training the image processing model
20 Microscope image
21 Microscope image of the training data
40 Image processing result
41 Virtually stained image
42 Target images/annotations of the training data
43 Chemically stained images
100 Microscopy system
B Image processing model
B1 Convolutional layer
C Evaluation criteria
F Filter mask
F1-F6 Filter masks
F′ Group of model parameter values
G Quality measure
G′ Quality measure, predefined for filter masks of the training data T′
K Contextual information
L Loss function for the training of the image processing model B
L′ Loss function for the training of the testing model Q′
O Optimizer
P Model parameter values of the image processing model B
Q Quality testing program
Q′ Machine-learned model (testing model) as quality testing program
q Quality statement
S1-S17 Steps of methods according to the invention
T Training data for training the image processing model
T′ Training data for training the testing model Q′

What is claimed is:

1. A microscopy system, comprising:
a microscope for image capture; and
a computing device that is configured to train, using training data, an image processing model to calculate an image processing result from at least one microscope image;
wherein the computing device comprises a quality testing program for testing a quality of the image processing model, wherein the quality testing program is configured to make a quality statement on a quality of the image processing model from learned model parameter values of the image processing model.

2. A computer-implemented method for testing a quality of a machine-learned image processing model configured to calculate an image processing result from at least one microscope image, the method including:
inputting learned model parameter values of the image processing model into a quality testing program which is configured to make a quality statement on a quality of the image processing model from input model parameter values; and
using the quality testing program to calculate a quality statement regarding a quality of the image processing model based on the learned model parameter values.

3. The computer-implemented method according to claim 2,
wherein for the calculation of the quality statement a quality measure is derived from the learned model parameter values and compared with reference values.

4. The computer-implemented method according to claim 2,
wherein the quality testing program makes the quality statement based on evaluation criteria relating to the model parameter values, wherein the evaluation criteria relate to one or more of the following:
a randomness or entropy of a group of model parameter values;
a similarity of a group of model parameter values to known or expected distributions;
an energy of filter weights of a convolutional layer;
a presence of inactive filter masks in the image processing model with model parameter values that lie exclusively below a predetermined threshold;
an invariability of model parameter values of activation functions over a plurality of training steps;
a presence of structures in groups of model parameter values;
a memorization of specific structures of training data in filter masks of the image processing model; and
a color distribution in filter masks of the image processing model.

5. The computer-implemented method according to claim 4,
wherein the quality testing program comprises a machine-learned model trained to make the quality statement based on one or more of the evaluation criteria.

6. The computer-implemented method according to claim 2,
wherein the quality testing program evaluates groups of model parameter values together and additionally takes into account information regarding a model parameter position within the image processing model as well as contextual information in order to calculate the quality statement.

7. The computer-implemented method according to claim 2,
wherein the quality testing program takes into account contextual information in addition to the model parameter values to calculate the quality statement, wherein the contextual information relates to one or more of the following:
initial values of model parameters of the image processing model at a beginning of a training;
an evolution of the model parameter values over a training;
training data of the image processing model;
a model architecture of the image processing model; and
information regarding an application for which microscope images were captured as training data of the image processing model; information regarding a microscope or microscope settings with which microscope images were captured as training data of the image processing model; a user identification; a specification of a sample type visible in microscope images of the training data of the image processing model.

8. The computer-implemented method according to claim 2,
wherein in cases where the quality statement confirms a usability of the image processing model:
the image processing model calculates image processing results from microscope images or, subject to a supplemental verification of a model quality, the image processing model calculates image processing results from microscope images.

9. The computer-implemented method according to claim 2,
wherein in cases where the quality statement categorizes the image processing model as unsuitable, a new training′ of the image processing model is implemented with a change, wherein the change relates to at least one of the following:
hyperparameters, an optimizer used or a regularization of a training′ of the image processing model;
a removal of model parameters from the image processing model or an addition of model parameters to the image processing model, or a change in architecture; or
a division into training and validation data or a selection of training and validation data.

10. The computer-implemented method according to claim 2,
wherein the quality testing program determines the change based on at least the model parameter values and contextual information regarding the image processing model.

11. The computer-implemented method according to claim 2, the method further comprising:
performing the quality testing of the image processing model during an ongoing training of the image processing model, and
continuing or reinitiating the training with changes as a function of the quality statement.

12. The computer-implemented method according to claim 2,
wherein the image processing model is configured to calculate a processing result in the form of at least one of the following from at least one microscope image:
a statement regarding whether certain objects are present in the microscope image;
geometric specifications relating to depicted objects; an identification, a number or characteristics of depicted objects;
a warning regarding analysis conditions, microscope settings, sample characteristics or image characteristics;
a control command for controlling the microscope or for a subsequent image evaluation or a recommendation of a control command for controlling the microscope or for a subsequent image evaluation;
an output image in which depicted objects are more clearly visible or are depicted in a higher image quality or in which a depiction of certain structures is suppressed;
a classification result that specifies a categorization into at least one of a plurality of possible classes as a function of a depicted image content; and
a semantic segmentation or detection of certain structures.

13. A computer program, comprising commands stored on a non-transitory computer-readable medium and which, when the program is executed by a computer, causes the execution of the method according to claim 2.
